(19) United States
(12) Patent Application Publication
(10) Pub. No.: US 2023/0219474 A1
(43) Pub. Date: Jul. 13, 2023

(54) ADDITIVELY MANUFACTURED CUSHION COMPONENT

(71) Applicant: Ford Global Technologies, LLC, Dearborn, MI (US)

(72) Inventors: Patrick Maloney, Livonia, MI (US); Siddharthan Selvasekar, Livermore, CA (US); Alexander Adam Perkins, Detroit, MI (US); Vijay Kiran Yellamraju, Dearborn, MI (US)

(73) Assignee: Ford Global Technologies, LLC, Dearborn, MI (US)

(21) Appl. No.: 17/575,032

(22) Filed: Jan. 13, 2022

(51) Int. Cl. B60N 2/70; B33Y 80/00; B60N 2/64

(52) U.S. Cl. CPC B60N 2/7017; B60N 2/7035; B33Y 80/00; B60N 2/646; B33Y 70/00

(57) ABSTRACT

A cushion component includes a lattice matrix having a first section comprised of a plurality of 3D cells. Each 3D cell of the plurality of 3D cells of the first section of the lattice matrix includes a face-centered cubic geometry. A second section of the lattice matrix is positioned below the first section and includes a plurality of 3D cells. Each 3D cell of the plurality of 3D cells of the second section of the lattice matrix includes a body-centered cubic geometry. The first section and the second section of the lattice matrix are integrated to define a monolithic structure comprised of a common material.

### FIELD OF THE DISCLOSURE

The present disclosure generally relates to a cushion component for a vehicle, and more particularly, to a cushion component that is created using an additively manufactured lattice matrix that provides customized elastic moduli and support for the cushion component.

### BACKGROUND OF THE DISCLOSURE

The present concept provides a unique structural configuration in a single support unit of a cushion component to provide customizable comfort settings.

### SUMMARY OF THE DISCLOSURE

According to a first aspect of the present disclosure, a cushion component includes a lattice matrix having a first section and a second section. The first section includes 3D cells having a first cubic geometry and a first elastic modulus. The second section includes 3D cells having a second cubic geometry that is different than the cubic geometry of the 3D cells of the first section and a second elastic modulus that is less than the elastic modulus of the 3D cells of the first section.

Embodiments of the first aspect of the present disclosure can include any one or a combination of the following features:
the first section includes one or more layers of the 3D cells having the first cubic geometry and the first elastic modulus;
the first elastic modulus of the 3D cells of the first section of the lattice matrix is higher than the second elastic modulus of the 3D cells of the second section of the lattice matrix;
each 3D cell of the 3D cells of the first section of the lattice matrix includes a plurality of faces, and each face of the plurality of faces includes a face-centered node;
each 3D cell of the 3D cells of the first section of the lattice matrix includes a plurality of peripheral nodes surrounding each face-centered node;
each 3D cell of the 3D cells of the first section of the lattice matrix includes a plurality of interconnecting links;
the plurality of interconnecting links includes links interconnecting the peripheral nodes and the face-centered node;
the plurality of interconnecting links further includes links interconnecting adjacent peripheral nodes.
the second elastic modulus of the 3D cells of the second section of the lattice matrix is lower than the first elastic modulus of the 3D cells of the first section of the lattice matrix;
each 3D cell of the 3D cells of the second section of the lattice matrix includes a cubic body having a body-centered node that is centrally disposed within the cubic body;
each 3D cell of the 3D cells of the second section of the lattice matrix includes a plurality of peripheral nodes surrounding the body-centered node;
each 3D cell of the 3D cells of the second section of the lattice matrix includes a plurality of interconnecting links; and
the plurality of interconnecting links includes links interconnecting the peripheral nodes and the body-centered node.

According to a second aspect of the present disclosure, a cushion component includes a lattice matrix having a first section comprised of a plurality of 3D cells. Each 3D cell of the plurality of 3D cells of the first section includes a face-centered cubic geometry. A second section is positioned below the first section. The second section is comprised of a plurality of 3D cells. Each 3D cell of the plurality of 3D cells of the second section includes a body-centered cubic geometry. The first section and the second section of the lattice matrix are integrated to define a monolithic structure comprised of a common material.

Embodiments of the second aspect of the present disclosure can include any one or a combination of the following features:
each 3D cell of the plurality of 3D cells of the first section of the lattice matrix includes a first elastic modulus that is higher than a second elastic modulus of each 3D cell of the plurality of 3D cells of the second section of the lattice matrix; and
each 3D cell of the plurality of 3D cells of the first and second sections of the lattice matrix include voids positioned between interconnecting links and nodes, and the voids of the second section are greater than the voids of the first section.

According to a third aspect of the present disclosure, a cushion component includes a first section comprised of a plurality of 3D cells. Each 3D cell of the plurality of 3D cells of the first section includes a plurality of faces. Each face of the plurality of faces includes a face-centered node to define a face-centered cubic geometry. A second section comprised of a plurality of 3D cells. Each 3D cell of the plurality of 3D cells of the second section includes a cubic body having a body-centered node that is centrally disposed within the cubic body to define a body-centered cubic geometry.

Embodiments of a third aspect of the present disclosure can include any one or a combination of the following features:
the first section and the second section are integrated to define a lattice matrix having a monolithic structure;
each 3D cell of the plurality of 3D cells of the first section includes a first elastic modulus that is higher than a second elastic modulus of each 3D cell of the plurality of 3D cells of the second section; and
each 3D cell of the 3D cells of the first section includes a plurality of peripheral nodes surrounding each face-centered node and a plurality of interconnecting links, the plurality of interconnecting links of each 3D cell of the 3D cells of the first section includes links interconnecting the peripheral nodes and the face-centered node and links interconnecting adjacent peripheral nodes within each 3D cell of the 3D cells of the first section, and each 3D cell of the 3D cells of the second section includes a plurality of peripheral nodes surrounding the body-centered node and a plurality of interconnecting links, the interconnecting links of each 3D cell of the 3D cells of the second section includes links interconnecting the peripheral nodes and the body-centered node within each 3D cell of the 3D cells of the second section.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top perspective view of a cushion component;

FIG. 2 is a cross-section view of the cushion component of FIG. 1 taken at line II;

FIG. 3 is a schematic top perspective view of a 3D cell having a face-centered cubic geometry;

FIG. 4 is a schematic top perspective view of a 3D cell having a body-centered cubic geometry; and

FIG. 5 is a top plan view of the cushion component of FIG. 1 taken at location V.

### DETAILED DESCRIPTION OF THE PREFERRED EMBODIMENTS

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

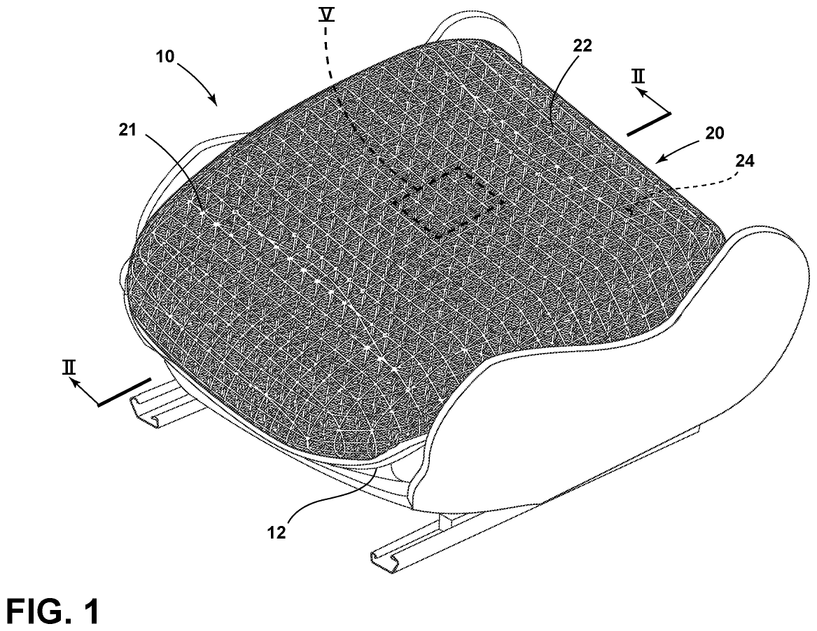

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an additively manufactured cushion component for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring now to FIG. 1, a cushion component 10 is shown in the form of a seat cushion. The cushion component 10 is shown in FIG. 1 as being supported on a base structure 12. The cushion component 10 is comprised of a lattice matrix 20 that is further comprised of multiple sections, as further described below. The lattice matrix 20 is contemplated to be a deflectable member providing a cushioning effect for a seat occupant that is similar to a cushioning effect provided by seat cushions comprised of a foam padding. It is contemplated that the cushion component 10 may include an outer casing or skin comprised of a leather, suede, polymeric or vinyl material that is stretched over the cushion component 10. It is further contemplated that the cushion component 10 may be comprised completely of the lattice matrix 20, such that the lattice matrix 20 is exposed to a user. The cushion component 10 shown in FIG. 1 can be used in any portion of a vehicle, such as front, rear and third row seating options for example. The lattice matrix 20 includes an upper section 22, which may be described herein as a first section 22 of the lattice matrix. The upper section 22 may cover an entirety of the cushion component 10 that is exposed to user, or a portion thereof. In assembly, the upper section 22 surrounds or is layered on top of a core section 24, as further described below.

As used herein, the term “lattice matrix” refers to a structural pattern of interconnected links that define cells or voids therebetween, wherein the overall pattern resembles an expanded material configuration. The cushioned components discussed herein are contemplated to be comprised of a single material used in an additive manufacturing process to form the lattice matrices thereof into monolithic structures. In this way, the cushioned components of the present concept include fully integrated component parts comprised of a common material that define overall monolithic structures. As used herein, the term “integrated” refers to component parts of a unitary whole that are formed together to provide the monolithic structure of the overall article. In this way, the term “integrated” is used herein to describe component parts that are formed together is a unitary whole, as opposed to components that are separately formed and later operably coupled to one another in assembly. As used herein, the term “monolithic structure” is used to describe a structure that is integrally formed in a forming process, such as an additive manufacturing technique. Additive manufacturing techniques contemplated for use with the present concept may include 3D printing, laser sintering and other known additive manufacturing techniques. In this way, the monolithic structures of the present concept provide unitary structures comprised of multiple configurations and features. It is noted that the monolithic structures of the present concept may include of a single or common material used in the additive manufacture of the structure.

Further, the cushioned components of the present concept are not only monolithic in structure, but are specifically configured to provide variated density profiles within lattice matrices thereof. As used herein, the term “density profile” is used to describe a relative hardness of a cushioned component or the lattice matrix thereof. Density profiles are comparable between components, wherein a greater density profile describes a component part that has reduced deflection capabilities as compared to a component part with increased deflection capabilities (i.e. lesser density profile). Thus, the cushioned components, or the lattice matrices thereof, of the present concept include density profiles that vary from one section to another to provide variated comfort settings. A density profile takes into account a degree of deflection of a part under a given force and can be expressed as a softness, or more likely, a hardness of the part.

As used herein, the terms “deflectable” or “deformable” refer to a component that is considered to be cushioning in nature, such that the component is compressible when under pressure from an applied force. The terms “deflectable” or “deformable” are also used herein to describe a component part that is flexibly resilient. In this way, a deflectable component part is contemplated to a be a part that can be compressed from an at-rest condition to a compressed condition under a compression force, and is further contemplated to resiliently return to the at-rest condition from the compressed condition after the compression force is removed. Thus, a deflectable or deformable lattice matrix described herein acts as a cushioning component that can support an occupant in a compressed or deformed condition and return to an at-rest condition when the occupant is removed from the cushion component.

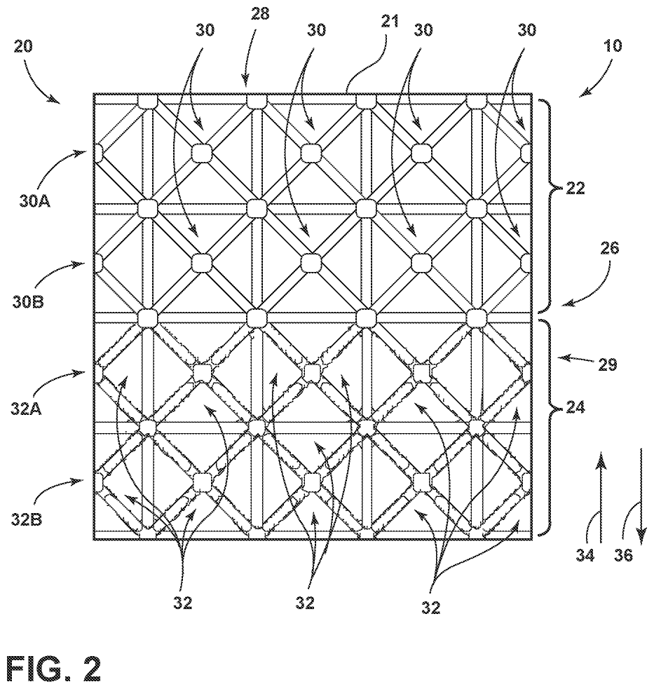

Referring now to FIG. 2, a cross-section of a portion of the cushion component 10 is shown. In the view of FIG. 2, a support surface 21 of the lattice matrix 20 of the cushion component 10 is shown, and contemplated to be a contact surface for an occupant. As shown in FIG. 2, the lattice matrix 20 includes a plurality of sections 26 which include the upper section 22 and the core section 24. Each section is contemplated to have a unique elastic modulus, and may be referred to herein as first and second sections. As used herein, the term “elastic modulus” refers to a stiffness or rigidity of a section or component part of a trim article. Elastic modulus is the ratio of stress, below the proportional limit, to the corresponding strain of a unit. Thus, a higher elastic modulus is associated with a stiffer or more rigid section or component part thereof. In terms of the stress-strain curve, the modulus of elasticity is the slope of the stress-strain curve in the range of linear proportionality of stress to strain. The greater the elastic modulus, the stiffer the material, or the smaller the elastic strain that results from the application of a given stress.

The upper or first section 22 includes a first elastic modulus that is contemplated to be higher than an elastic modulus of any other section of the plurality of sections 26. As further shown in FIG. 2, the core or second section 24 of the lattice matrix 20 is positioned adjacent to and below the first section 22. In this way, the second section 24 abuts the first section 22. The second section 24 of the lattice matrix 20 includes a second elastic modulus that is lower than the first elastic modulus of the first section 22. The sections 22 and 24 of the plurality of sections 26 may be referred to herein as layers that are part of a plurality of layers of the lattice matrix 20. Having varying elastic moduli, the sections 22 and 24 provide variable physical responses to loads or forces received. The variated elastic moduli between the sections 22 and 24 are attributed to differences in the unit cell geometry between the sections 22 and 24 in the additively manufactured lattice matrix 20, as further described below.

With further reference to FIG. 2, the differences in the sections 22 and 24 of the lattice matrix 20 provide for an overall lattice structure that can be tailored to comfort and energy absorption by changing the geometry of the unit cells that make up the lattice matrix 20 in the different sections 22 and 24. The first section 22 is configured to be an energy absorbing lattice section of the lattice matrix 20. This first section 22 is contemplated to outperform foam by increasing the area under the stress vs. strain curve. Thus, for an energy absorbing application, stress should peak and then remain constant as strain increases to maximize the area under the stress vs. strain curve. Stress is an internal force resulting from an applied load. It acts on the cross-section of a mechanical or structural component. Strain is the change in shape or size of a body that occurs whenever a force is applied. The second section 24 of the lattice matrix 20 is configured to be a comfort tailored lattice section. The comfort tailored lattice of the second section 24 of the lattice matrix 20 is contemplated to outperform foam in linearity of the stress vs. strain curve and maximum strain. Thus, in the second section 24 of the lattice matrix 20, stress should build linearly with strain under an applied load. As noted above, the lattice matrix 20 is contemplated to be an integrated or monolithic structure, such that the first section 22 and the second section 24 of the lattice matrix 20 can be printed together using an additive manufacturing process to create the lattice matrix 20 as a unitary whole.

The multiple sections of the lattice matrix 20 are contemplated to be comprised of a common material, such that the plurality of sections 26 are integrated to define a unitary member in the lattice matrix 20. The lattice matrix 20 is contemplated to be comprised of a build material constructed using an additive manufacturing technique, whereby a layer-by-layer deposition process is used to print, or otherwise deposit, the build material. The build material may include a polymeric material that is cured after deposition to form the various sections of the lattice matrix 20. In FIG. 2, the different sections 22 and 24 of the lattice matrix 20 are combined to satisfy applications requiring both comfort and energy absorption. This can apply to automotive seating for sports such as baja racing, as well as non-automotive recreational vehicle seats like ATVs, jet skis and snowmobiles.

As further shown in FIG. 2, the first section 22 of the lattice matrix 20 defines an outer layer of the lattice matrix 20 which further defines the support surface 21 of the cushion component 10. This outer layer defined by the first section 22 includes a first overall elastic modulus. As further shown in FIG. 2, the second section 24 of the lattice matrix 20 defines an inner or core layer disposed below the outer layer. As noted above, the second section 24 of the lattice matrix 20 includes a second overall elastic modulus that is lower than the first overall elastic modulus of the outer layer (defined by the first section 22).

The layers or sections 22 and 24 of the plurality of sections 26 of the lattice matrix 20 are comprised of a plurality of three-dimensional (3D) cells or cubics 28, 29, respectively, as shown in FIG. 2. Specifically, the first section 22 of the lattice matrix 20 includes a plurality of 3D cells 28 which is comprised of individual 3D cells 30. The 3D cells 30 are contemplated to have a first cubic geometry, as further described below. The first cubic geometry of the 3D cells 30 of the first section 22 of the lattice matrix 20 provides for the energy absorption qualities described above. The second section 24 of the lattice matrix 20 includes a plurality of 3D cells 29 which is comprised of individual 3D cells 32. The 3D cells 32 are contemplated to have a second cubic geometry that is different than the first cubic geometry of the 3D cells 30 of the first section 22 of the lattice matrix 20, as further described below. The second cubic geometry of the 3D cells 32 of the second section 24 of the lattice matrix 20 provides for the comfort characteristics qualities described above.

As further shown in FIG. 2, the 3D cells 30 of the first section 22 are contemplated to have a higher elastic modulus as compared to the 3D cells 32 of the second section 24. Thus, the second section 24 of the lattice matrix 20 is contemplated to have a lower overall elastic modulus, as compared to the overall elastic modulus of the first section 22 of the lattice matrix 20, as the second section 24 of the lattice matrix 20 includes the 3D cells 32 having a lower elastic modulus as compared to the 3D cells 30 of the first section 22. In this way, the first section 22 of the lattice matrix 20 is a stiffer more rigid part of the lattice matrix 20, as compared to the second section 24 of the lattice matrix 20 for providing better energy absorption features. Said differently, the first section 22 of the lattice matrix 20 is contemplated to have a higher overall elastic modulus, as compared to the overall elastic modulus of the second section 24 of the lattice matrix 20, as the first section 22 of the lattice matrix 20 includes the 3D cells 30 having a higher elastic modulus as compared to the 3D cells 32 of the second section 24. In this way, the second section 24 of the lattice matrix 20 is a softer more easily deformable part of the lattice matrix 20, as compared to the first section 22 of the lattice matrix 20 for providing better comfort orientated features. The plurality of 3D cells 28 of the first section 22 of the lattice matrix 20 includes first and second layers 30A, 30B of 3D cells 30. The plurality of 3D cells 29 of the second section 24 of the lattice matrix 20 includes first and second layers 32A, 32B of 3D cells 32. It is contemplated that more or less layers may be provided in each section of the lattice matrix 20 as needed for a given application. In the embodiment shown in FIG. 2, an elastic modulus gradient 34 of increasing stiffness is provided from the second section 24 to the first section 22 of the lattice matrix 20. Similarly, in the embodiment shown in FIG. 2 an elastic modulus gradient 36 of decreasing stiffness is provided from the first section 22 to the second section 24 of the lattice matrix 20.

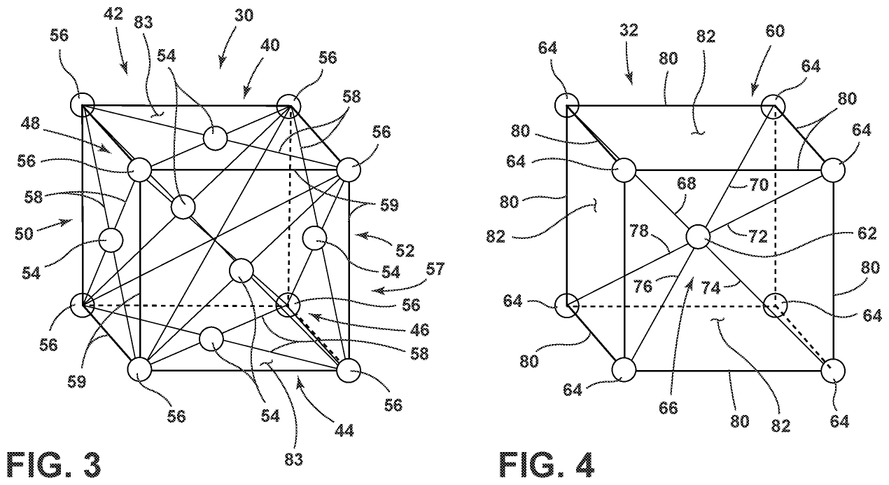

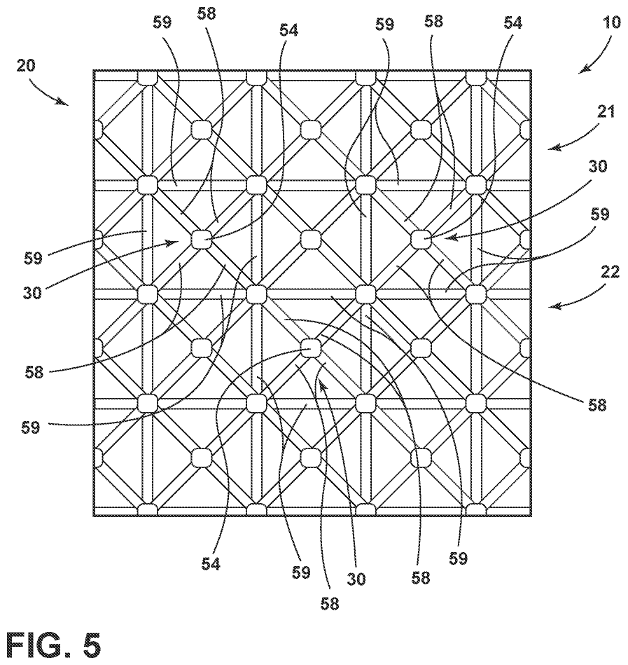

Referring now to FIG. 3, a 3D cell 30 is shown in a schematic form to illustrate the first cubic geometry of 3D cells 30 which comprise the first section 22 of the lattice matrix 20. The 3D cell 30 shown in FIG. 3 includes a plurality of faces 40 which is comprised of upper and lower faces 42, 44, front and rear faces 46, 48 and side faces 50, 52. Each face 42, 44, 46, 48, 50 and 52 of the plurality of faces 40 of the 3D cell 30 includes a face-centered node 54 disposed within a plane defined by the respective face in which the face-centered node 54 is positioned. As such, the 3D cell 30 shown in FIG. 3 includes the first cubic geometry which is a face-centered cubic geometry, wherein each face 42, 44, 46, 48, 50 and 52 of the plurality of faces 40 of the 3D cell 30 includes the face-centered node 54. The 3D cell 30 further includes a number of peripheral nodes 56 surrounding each face-centered node 54, and interconnecting links 58. As shown in FIG. 3, the interconnecting links 58 interconnect the peripheral nodes 56 with the face-centered nodes 54. Further, interconnecting links 59 interconnect adjacent peripheral nodes 56. The interconnecting links 58, 59 define a plurality of links 57 for 3D cell 30. In this way, the first cubic geometry of the 3D cells 30 includes numerous interconnecting links 58, 59 disposed in a plurality of directions on each face 42, 44, 46, 48, 50 and 52 of the plurality of faces 40 of the 3D cell 30 with face-centered nodes 54; all of which help to increase the elastic modulus of the 3D cells 30 for better energy absorption.

Referring now to FIG. 4, a 3D cell 32 is shown in a schematic form to illustrate the second cubic geometry of 3D cells 32 which comprise the second section 24 of the lattice matrix 20. The 3D cell 32 includes a cubic body 60 and a body-centered node 62 that is centrally disposed within the cubic body 60. As such, the 3D cell 32 shown in FIG. 4 includes the second cubic geometry which is a body-centered cubic geometry, wherein the cubic body 60 of the 3D cell 32 includes the body-centered node 62. The 3D cell 32 further includes a number of peripheral nodes 64 surrounding the body-centered node 62, and a plurality of interconnecting links 66. The plurality of interconnecting links 66 outwardly extending from the body-centered node 62 in various directions. Specifically, links 68, 70, 72, 74, 76 and 78 of the plurality of interconnecting links 66 extend outwardly from the body-centered node 62 to interconnect the body-centered node 62 with the peripheral nodes 64. As further shown in FIG. 4, interconnecting links 80 are shown interconnecting adjacent peripheral nodes 64. The interplay of the plurality of interconnecting links 66 provides for the second elastic modulus of the 3D cell 32.

In comparing FIGS. 3 and 4, the 3D cell 30 of FIG. 3 includes many more nodes 54, 56 and interconnecting links 58, 59 in its first or face-centered cubic geometry as compared to the 3D cell 32 of FIG. 4 with its second or body-centered cubic geometry. In this way, the 3D cell 32 of FIG. 4 has greater voids 82 positioned between the nodes 62, 64 and the plurality of interconnecting links 66, thereby making the 3D cell 32 of FIG. 4 more deformable than the 3D cell 30 of FIG. 3. The 3D cell 30 of FIG. 3 has comparably lesser voids 83 positioned between the nodes 54, 56 and the plurality of interconnecting links 66. As such, the second elastic modulus of the 3D cells 32 of the second section 24 of the lattice matrix 20 is less than the first elastic modulus of the 3D cells 30 of the first section 22 of the lattice matrix 20. Said differently, the first elastic modulus of the 3D cell 30 of FIG. 3 is greater than the second elastic modulus of the 3D cell 32 of FIG. 4.

The 3D cells 30 and 32 of the present concept are contemplated to have similar dimensions with respect to link thickness and node dimension. Further, as noted above, the 3D cells 30 and 32 are contemplated to be comprised of a similar build material. Thus, the varying elastic moduli provided between the 3D cells 30 and 32 is largely due to the positioning of the nodes and the spacing of the voids 82, 83 disposed between the plurality of interconnecting links 57, 66 and the nodes 54, 56 and 62, 64 of the 3D cells 30 and 32, respectively. The arrangement of the plurality of interconnecting links 57 and the nodes 54, 56 of the 3D cells 30 is provide by the first cubic geometry of the 3D cells 30, which is a face-centered cubic geometry. The arrangement of the plurality of interconnecting links 66 and the nodes 62, 64 of the 3D cells 32 is provide by the second cubic geometry of the 3D cells 32, which is a body-centered cubic geometry.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A cushion component, comprising:
a lattice matrix having a first section and a second section, wherein the first section includes 3D cells having a first cubic geometry and a first elastic modulus, and further wherein the second section includes 3D cells having a second cubic geometry that is different than the cubic geometry of the 3D cells of the first section and a second elastic modulus that is less than the elastic modulus of the 3D cells of the first section.

2. The cushion component of claim 1, wherein the first section includes one or more layers of the 3D cells having the first cubic geometry and the first elastic modulus.

3. The cushion component of claim 1, wherein the first elastic modulus of the 3D cells of the first section of the lattice matrix is higher than the second elastic modulus of the 3D cells of the second section of the lattice matrix.

4. The cushion component of claim 1, wherein each 3D cell of the 3D cells of the first section of the lattice matrix includes a plurality of faces, and further wherein each face of the plurality of faces includes a face-centered node.

5. The cushion component of claim 4, wherein each 3D cell of the 3D cells of the first section of the lattice matrix includes a plurality of peripheral nodes surrounding each face-centered node.

6. The cushion component of claim 5, wherein each 3D cell of the 3D cells of the first section of the lattice matrix includes a plurality of interconnecting links.

7. The cushion component of claim 6, wherein the plurality of interconnecting links includes links interconnecting the peripheral nodes and the face-centered node.

8. The cushion component of claim 7, wherein the plurality of interconnecting links further includes links interconnecting adjacent peripheral nodes.

9. The cushion component of claim 1, wherein the second elastic modulus of the 3D cells of the second section of the lattice matrix is lower than the first elastic modulus of the 3D cells of the first section of the lattice matrix.

10. The cushion component of claim 1, wherein each 3D cell of the 3D cells of the second section of the lattice matrix includes a cubic body having a body-centered node that is centrally disposed within the cubic body.

11. The cushion component of claim 10, wherein each 3D cell of the 3D cells of the second section of the lattice matrix includes a plurality of peripheral nodes surrounding the body-centered node.

12. The cushion component of claim 11, wherein each 3D cell of the 3D cells of the second section of the lattice matrix includes a plurality of interconnecting links.

13. The cushion component of claim 12, wherein the plurality of interconnecting links includes links interconnecting the peripheral nodes and the body-centered node.

14. A cushion component, comprising:
a lattice matrix comprising:
a first section comprised of a plurality of 3D cells, wherein each 3D cell of the plurality of 3D cells of the first section includes a face-centered cubic geometry; and
a second section positioned below the first section, the second section comprised of a plurality of 3D cells, wherein each 3D cell of the plurality of 3D cells of the second section includes a body-centered cubic geometry, wherein the first section and the second section of the lattice matrix are integrated to define a monolithic structure comprised of a common material.

15. The cushion component of claim 14, wherein each 3D cell of the plurality of 3D cells of the first section of the lattice matrix includes a first elastic modulus that is higher than a second elastic modulus of each 3D cell of the plurality of 3D cells of the second section of the lattice matrix.

16. The cushion component of claim 15, wherein each 3D cell of the plurality of 3D cells of the first and second sections of the lattice matrix include voids positioned between interconnecting links and nodes, and further wherein the voids of the second section are greater than the voids of the first section.

17. A cushion component, comprising:
a first section comprised of a plurality of 3D cells, wherein each 3D cell of the plurality of 3D cells of the first section includes a plurality of faces, wherein each face of the plurality of faces includes a face-centered node to define a face-centered cubic geometry; and
a second section comprised of a plurality of 3D cells, wherein each 3D cell of the plurality of 3D cells of the second section includes a cubic body having a body-centered node that is centrally disposed within the cubic body to define a body-centered cubic geometry.

18. The cushion component of claim 17, wherein the first section and the second section are integrated to define a lattice matrix having a monolithic structure.

19. The cushion component of claim 18, wherein each 3D cell of the plurality of 3D cells of the first section includes a first elastic modulus that is higher than a second elastic modulus of each 3D cell of the plurality of 3D cells of the second section.

20. The cushion component of claim 19, wherein each 3D cell of the 3D cells of the first section includes a plurality of peripheral nodes surrounding each face-centered node and a plurality of interconnecting links, wherein the plurality of interconnecting links of each 3D cell of the 3D cells of the first section includes links interconnecting the peripheral nodes and the face-centered node and links interconnecting adjacent peripheral nodes within each 3D cell of the 3D cells of the first section, and further wherein each 3D cell of the 3D cells of the second section includes a plurality of peripheral nodes surrounding the body-centered node and a plurality of interconnecting links, wherein the interconnecting links of each 3D cell of the 3D cells of the second section includes links interconnecting the peripheral nodes and the body-centered node within each 3D cell of the 3D cells of the second section.
